(19) United States
(12) Patent Application Publication
(10) Pub. No.: US 2007/0278770 A1
(43) Pub. Date: Dec. 6, 2007

(54) Insert molded feature for airbag covers

(76) Inventors: Ken Love, Collinston, UT (US); Chuck Richards, Farmington, UT (US); Quin Soderquist, South Weber, UT (US)

Correspondence Address: Sally J. Brown;AUTOLIV ASP, INC., 3350 Airport Road, Ogden, UT, 84405, US

(21) Appl. No.: 11/446,103

(22) Filed: Jun. 2, 2006

(51) Int. Cl. B60R 21/215; B60R 13/10

(52) U.S. Cl. 280/728.3

(57) ABSTRACT

A new type of airbag cover and method for making the same is described herein. The airbag cover will generally have an insert that includes one or more logos, indicia, symbols, trademarks, etc. that denote the vehicle manufacturer. A base will then be molded around this insert. The base and the insert are made of the same (or substantially the same) materials. However, the color used for the insert will differ from the color used for the base. The fact that different colors are used means that the indicia on the insert will be visually appealing and “eye-catching” to the consumer. Once the base is molded to the insert, these two features will chemically bond together. The indicia and the base material may be chemically and/or mechanically bonded together. Generally, this bonding is accomplished such that there is a continuous fit between the insert and the base.

### BACKGROUND OF THE INVENTION

1. Technical Field

The present invention relates to airbag covers. More specifically, the present invention is a new type of airbag cover containing the manufacturer's indicia or logo as well as a method of manufacturing the same.

2. Description of the Prior Art

Vehicle airbag systems are known in the art and have been credited with greatly increasing the overall safety of motor vehicles. Specifically, these airbag systems are designed such that during an accident, one or more airbags will be rapidly inflated and will be positioned between the vehicle occupant and the hard surfaces of the vehicle interior. These inflated airbags will inhibit the vehicle occupant from impacting the interior surfaces of the vehicle and will thus greatly reduce the likelihood that the occupant will experience significant injuries in the crash.

Because of the increased safety that airbags provide, customers are often drawn to vehicles having airbag systems. As a result, vehicle manufactures often construct ads and promotional materials that will tout the vehicle's airbag systems. For example, ads may be constructed which tout the number of airbag systems equipped on the vehicle (i.e., that the vehicle has 4 or 5 airbag systems, etc.) or that the vehicle includes a particular type of airbag system (i.e., that the vehicle includes a side curtain airbags, overhead airbags, passenger airbags, etc.).

Moreover, because customers are drawn to airbag systems, vehicle manufactures often try to increase the visibility and image of their airbag modules within the vehicle. To this end, manufacturers will often place their company's indicia on the airbag cover. As used herein, the term “indicia” refers to any type of symbol, logo, trademark, letter, picture, emblem or other marking used by manufacturers. A common example of a well-known indicia is the stylized letter “H” that is used by Honda Motor Co., Ltd. on all “Honda” brand cars. Currently, most all steering wheel airbag systems (and other airbag systems as well) will have at least one indicia placed on the airbag cover and visible to the customer. As is known in the art, certain labeling is required by law to be on an airbag cover. This labeling will not be highlighted to consumers. However, manufacturers will often place their indicia on the airbag cover to enhance the styling and aesthetics of the cover. The driver airbag cover is constantly in front of the driver. Thus, manufacturers like to place their indicia on this cover. Similarly, manufacturers also like their indicia on this cover to stand out for name recognition and pleasing visual appearance.

However, as is known in the art, placing a company's logo or indicia on an airbag cover is not as easy or convenient as it first may appear. Of course, the easiest way to place an indicia on the airbag cover is to construct the cover and then mount a separate logo (made of metal, plastic, or other materials) to this cover. Generally, such mounting occurs through “secondary attachment mechanisms” such as fasteners, welding, adhesives, glue, attachment flanges, attachment members, brackets, etc. The problem with these known methods of affixing indicia is that they will greatly increase the cost and complexity of manufacturing. In fact, the use of some of these attachment mechanisms may increase the cost of each airbag system by nearly $1.50. Likewise, the use of these external indicia as well as secondary attachment mechanisms can, if installed improperly, affect the deployment of the airbag. As a result, most vehicle manufacturers believe that mounting a separate logo or indicia to the airbag cover is not optimal. Some additional concerns with current airbag emblems is that these products are made of rigid materials (e.g., stamped aluminum, ABS plastic, etc.). These rigid and stiff indicia do not flex compatibly with the distorted base cover material during the deployment of the airbag. This can result in additional design features or effort during development to ensure that indicia is retained. Moreover, the stiff, harder indicia can result in increased injury potential to an out-of-position occupant during the deployment. If the occupant is too close to the airbag door when the airbag deployment, then the hard indicia could contact the occupant.

Some vehicle manufacturers choose to place their indicia on the airbag cover by simply molding the cover so that it includes an indicia or other similar feature. While this method is relatively inexpensive, the resulting airbag cover and indicia will be made of the same, unitone color. These one-color systems will generally not have the same visual appeal to consumers as do more elaborate, multi-colored systems. As a result, vehicle manufacturers generally do not prefer these single color systems.

Recently, vehicle manufacturers have devised a third, distinct way to introduce the company indicia onto the airbag cover. Such new processes generally involve constructing the indicia from a hard material as a first step and then molding (in a tool or press) the remaining portions of the cover around this hardened material. Of course, this manufacturing method has its own disadvantages. For example, this method can be expensive, complex, and can produce large quantities of unusable scrap. Moreover, the molding process will usually require the use of a flange, pin, or other similar feature that is designed to hold the molded emblem against the tool surface during the molding process. If the indicia somehow slips or moves during the molding process, there can be “shut-off” issues resulting in flash around the indicia and/or damage to the surface of the indicia. Perhaps most significantly, the use of the hard material in the cover greatly increases the risk that the cover will fragment or splinter during deployment (especially if this hard material is required to flex or stretch during deployment). Thus, given all of these drawbacks and pitfalls associated with using these hard, molded indicia, these methods for manufacturing airbag covers have not been widely accepted or used in the industry.

Finally, some vehicle manufacturers have included additional colors on the airbag cover in order to draw further attention to the manufacturer's indicia or logo. The introduction of these color schemes is generally accomplished through known masking and painting techniques. However, the use of such painting/masking techniques greatly increases the cost and complexity of the manufacturing processes. Moreover, such painting processes are usually not exact and will create large quantities of scrap/unusable materials. As such, manufacturers generally waste valuable time, money and resources in using these known painting and masking processes to draw further attention to the manufacturer's indicia or logo, or to simply improve styling

Thus, based upon the foregoing, it is clear that a new type of airbag cover as well as a new method of affixing a company's indicia to the cover is needed in the art. Such products and methods are disclosed herein.

### BRIEF SUMMARY OF THE INVENTION

The present embodiments relate to a new type of airbag cover. This airbag will include an indicia of the manufacturer and will be made of thermoplastic or other similar materials.

In general, the airbag cover will include two elements, an insert and a base. The insert will include the indicia. In general, the insert will be made of the same (or substantially the same) material as is used in the base. However, the difference between these two elements will be highlighted by color. Specifically, the indicia (found on the insert) will be made of a different color than the base. For example, embodiments may be made in which the base is made of a lighter color (such as tan) and the indicia is made of a darker color (such as blue or black). Likewise, embodiments may be made in which the base is made of a darker color and the indicia is made of a lighter color. Of course, all sorts and varieties of color combinations are possible.

In other embodiments, the insert may comprise a surrounding portion that surrounds the indicia. This surrounding portion may be the same color as the indicia or it may be made from a different color as the indicia. For example, embodiments may be constructed in which both the indicia and the surrounding portion are made from a darker color (such as blue or black) and the base is made from a lighter color (such as tan). Again, other combinations and permutations of colors are allowed. In yet further embodiments, the indicia may be made from a first color (such as red) and the surrounding portion made of a second color (white) and the base made from a third color (such as black). The net result of this pattern would be a three-color system in which the indicia (red) would be appear mounted on successive backgrounds of white and black. Of course, other types of color schemes/combinations are clearly known to those of skill in the art.

It should be noted that the insert and the base will be melded/connected together. Because the insert and the base are formed of the same material, this occurs via bonding, such as chemical bonding, physical bonding, mechanical bonding, etc. Preferably, the melding process forms a physical, chemical, or mechanical bond between the insert and the base such that there is a continuous fit between the insert and the base—e.g., the base and the insert become as one. In other words, there will be a smooth transition between the base and the insert such that there are no gaps, ridges, or other features indicating a break between the base and the insert. Rather, the only distinguishing feature that illustrates the difference between the base and the insert/indicia is the different colors used on these features.

In order to produce the covers of the present embodiments, the insert containing the indicia must be obtained. In many embodiments, this will occur by molding the insert from the same (or substantially the same) material that is used to form the base. This molding will usually occur by placing the material in a mold or cast that has been pre-cut into the shape of the insert (with the indicia). Once the insert has been obtained, the insert may then be placed in a cover manufacturing tool. This tool is a press or mold that is designed to mold/create airbag covers. Accordingly, the tool will be designed and shaped such that the ultimate product formed from the tool will be that of the desired airbag cover.

After the insert has been introduced and positioned within the tool, a quantity of the base material will then be introduced into the tool. Generally, the base material will be hot—i.e., of sufficient temperature such that a bond will form between the insert and the base material but not a temperature to deform or misshape the insert. As the base material and the material of the insert are the same (or substantially the same), this bond will generally be readily formed. Finally, once the base material has been introduced into the tool, the base material will be molded about the insert. In many embodiments, this molding may involve closing the lid (or cavity side) of the tool and applying sufficient pressure such that the base material forms/molds into the desired form of the base and forms a bond between the base and the insert. In other embodiments, an injection molding machine maybe used as the tool. In these embodiments, the insert will be placed in one half of the mold. Once the insert is in place, the two halves of the mold will come together and the base material will be introduced under pressure into the mold. The mold will shape the base material into the proper configuration and bonding between the insert and the base material will occur.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is perspective view of an airbag cover according to the present embodiments;

FIG. 2 is cross-sectional view of the airbag cover shown in FIG. 1 taken along the line 2-2;

FIG. 3 is perspective view of the inward (rear) surface of an insert for the cover of FIG. 1;

FIG. 4 is perspective view of another embodiment of an airbag cover according to the present invention;

FIG. 5 is perspective view of another embodiment of an airbag cover according to the present invention;

FIG. 6A is a perspective view of a mounting flange that may be used in conjunction with the present embodiments; and

FIG. 6B a perspective view that illustrates the way in which the airbag covers of the present embodiments may be constructed.

### DETAILED DESCRIPTION OF THE INVENTION

The presently preferred embodiments of the invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

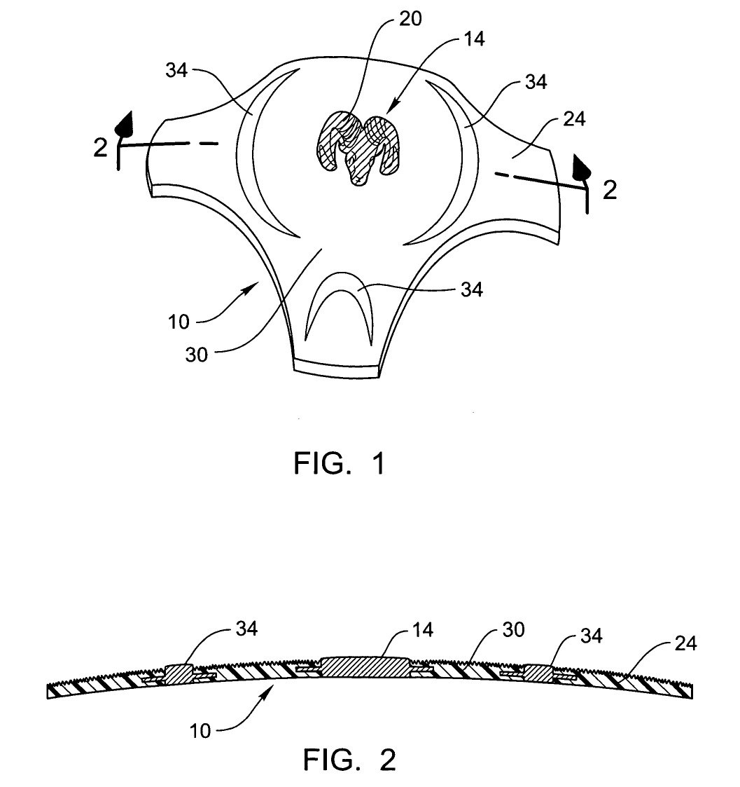

Referring now to FIG. 1, a perspective view of a new type of airbag cover 10 according to the present embodiments is illustrated. As shown in FIG. 1, the airbag cover 10 is designed such that it may be used in conjunction with a steering wheel airbag system (not shown). More particularly, the airbag cover 10 is designed such that it will conceal an airbag that is mounted within the steering wheel. Of course, the depiction in FIG. 1 does not limit the present embodiments to airbag covers used with steering wheel airbag systems. On the contrary, the cover 10 of the present embodiments may be designed for use with other types of vehicle airbag systems including overhead airbag systems, passenger airbag systems, side curtain airbag systems, or any other type of airbag system found in a motor vehicle.

In general, the airbag cover 10 is made of a thermoplastic or other material known in the art. Vinyl and/or other types of plastic may also be used. Generally, the material chosen for the cover 10 will be capable of receiving a variety of dyes or pigments so that the manufacture can select/modify the color of the airbag cover to match the decor of the vehicle interior.

The cover 10 comprises an insert 14 that includes an indicia 20. As noted above, the indicia 20 is any sort of logo, trademark, letter, picture, emblem, or other marking used by manufacturers to identify their products or goods. As shown in FIG. 1, the indicia 20 is a picture of ram's head, which is a trademark owned by the Chrysler Corporation and is associated with “Dodge” brand automobiles. Of course, other types of logos, pictures, etc. may also be used as the indicia 20.

The insert 14 will be melded to a base 24. (The way in which this melding process occurs will be discussed in greater detail below.) The base 24 is made of a base material 30, which as noted above, is thermoplastic (or another similar material). The insert 14 will be made of the same or substantially the same material as the base material 30. Thus, the entire airbag cover 10 will be made of the same or substantially the same material.

However, unlike many of the previously known airbag covers with unitone, molded logos, the airbag cover 10 will have an indicia 20 that is easily seen by consumers. The reason for this is that the indicia 20 is made of a different color than the color that is used for the base 24. Thus, as shown in FIG. 1, the base 24 is made of a lighter color (such as tan) and the indicia 20 is made of a darker color (such as blue or black). Of course, other color combinations are also possible in other embodiments.

Additional colors may also be used on either the base 24 or the insert 14. For example, in the embodiment shown in FIG. 1, additional colored portions 34 have been added to the base 24 to improve the visual appeal and decor of the cover 10. Likewise, additional embodiments may be constructed in which the insert 14 comprises multiple colors. For example, embodiments may be constructed in which the indicia 20 comprises a first color and then the area of the insert that surrounds the indicia 20 comprises a second color that is distinct from the first color and distinct from the color used for the base 24. Still other embodiments may be constructed in which the indicia 20 and the area of the insert 14 surrounding the indicia 20 are made of the same color. Those of skill in the art will appreciate the variety of different color patterns and arrangement that are within the scope of the present embodiments.

Referring now to FIG. 2, a cross-sectional view illustrates the cover 10 and the way in which the insert 14 will be melded/connected to the base 24. Specifically, the melding process occurs such that there is a continuous fit between the insert 14 and the base 24. (The base 24 is shown in FIG. 1.) In other words, there will be a smooth transition between the base 24 and the insert 14 such that there are no gaps, ridges, or other features indicating a break between the base 24 and the insert 14. Rather, the only distinguishing feature that illustrates the difference between the base 24 and the insert 14/indicia 20 is the different colors used on these features.

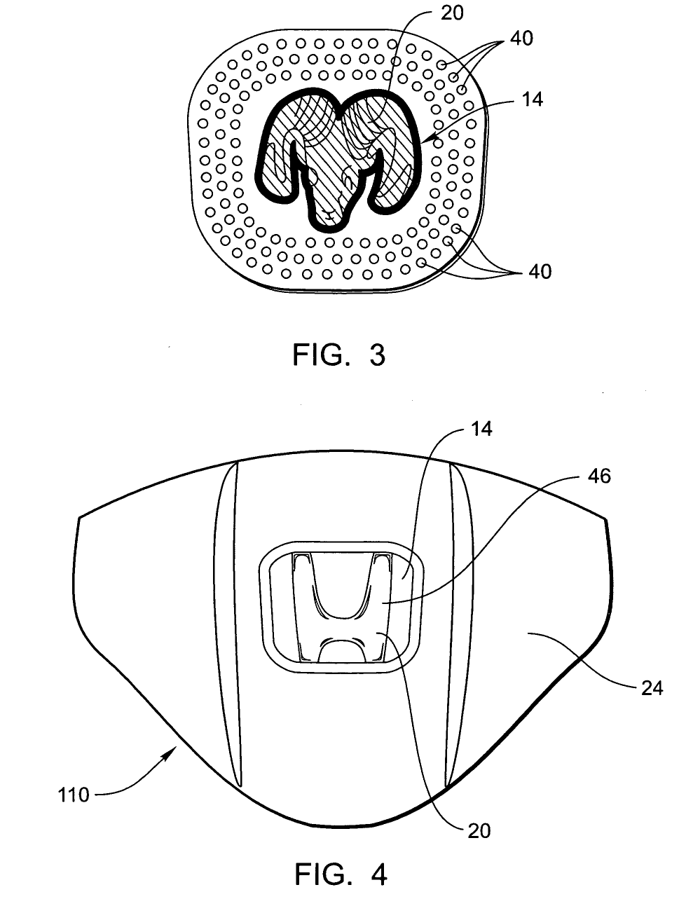

Referring now to FIG. 3, the rear (inward) side of an insert 14 of the cover 10 is illustrated. Again, this Figure illustrates the continuous meld that occurs between the insert 14 and the base 24 (shown in FIG. 1). However, as shown in FIG. 3, various circular features 40 are visible on the back side of the cover 10. These circular features 40 are caused by pins or other mounting features that may be used to hold the insert 14 in the proper position during the melding process (as will be discussed below). Of course, the use of such pins/mounting features is optional and will depend upon the particular embodiment. It should be noted that the pins/mounting features are arranged such that the circular features 40 only are formed away from the front of the cover 10—i.e., not visible to the consumer during normal use. This can be on the rear side of the cover 10 or within the center of the base 24 thickness.

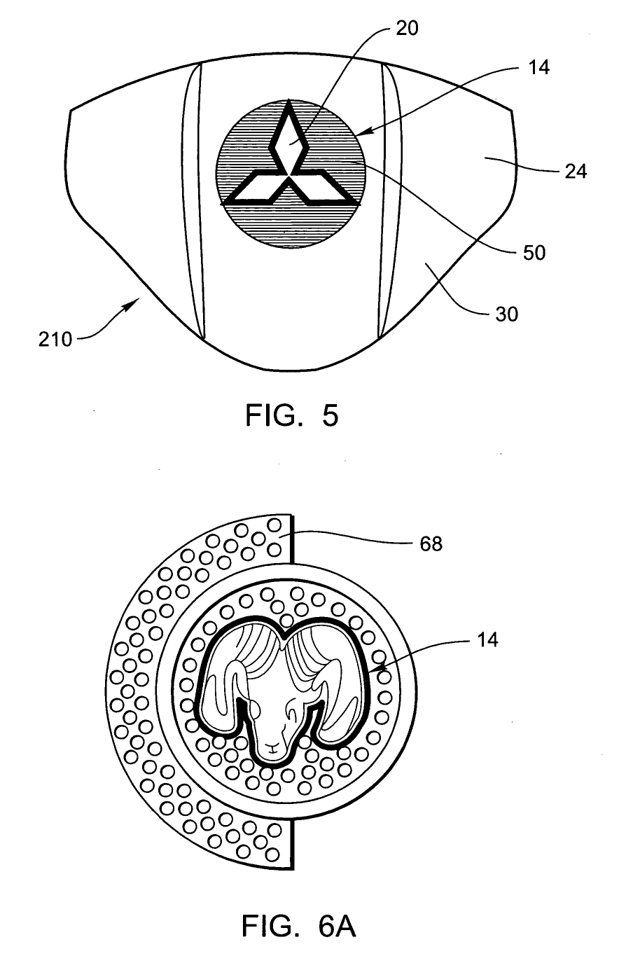

Referring now to FIGS. 4 and 5, additional embodiments of covers taught by the present embodiments are illustrated. Specifically, FIG. 4 depicts a cover 110 that includes an indicia 20 that is associated with “Honda” brand cars and is owned by the Honda Motor Co., Ltd. of Japan. However, in order to further make the insert 14 and the indicia 20 stand out for consumers, the insert 14 and the indicia 20 have been chrome plated with metallic chrome 46. Such chrome plating will generally be accomplished prior to the melding of the base 24 to the insert 14.

FIG. 5, on the other hand, illustrates a cover 210 that includes an indicia 20 associated with “Mitsubishi” brand cars and is owned by the Mitsubishi Jidosha Kogyo Kabushiki Kaisha Corporation of Tokyo, Japan. However, unlike the previous embodiments, the cover 210 includes the insert 14 which has the indicia 20 made of a first color (red) and a surrounding portion 50 made of a second color (white). In the cover 210, the insert 14 is then attached to a base 14 that is made of a darker (black) color. The net result is an eye-catching indicia 20 which appears to be mounted on a successive backgrounds of white and black. Of course, other types of color schemes/combinations are clearly known to those of skill in the art.

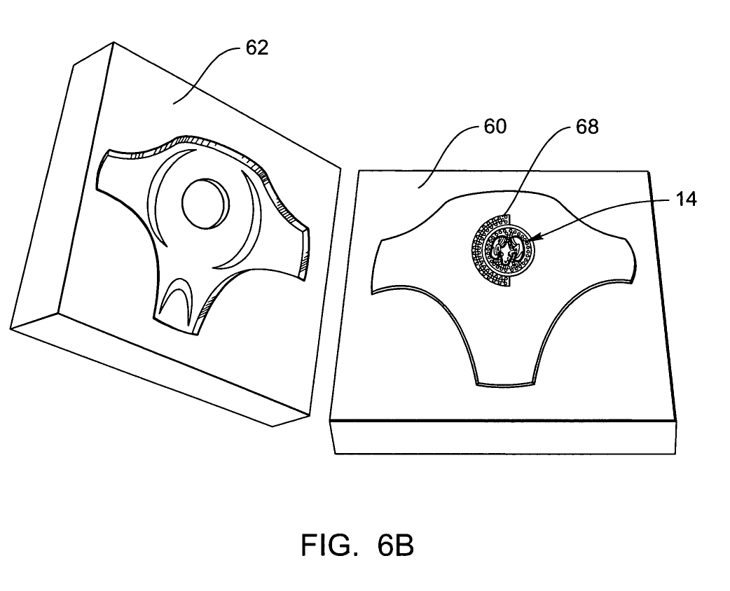

Referring now to FIG. 6A, a mounting flange 68 is illustrated. The mounting flange 68 is of the type that is known in the art. As explained in greater detail herein, an insert 14 may be positioned on the flange 68 prior to the incorporation of the insert into the cover 10, 110, 210. As shown in FIG. 6A, the insert 14 is positioned on the flange 68. The use of such a flange 68 is optional. However, when such a flange 68 is used, it will provide an additional bonding area and features between the base 24 (not shown in FIG. 6A) and the insert 14 and thereby increase the strength of the bond between these components. Base material can flow through the holes of the flange and create a mechanical bond in addition to more are for a chemical (or physical) bond.

Referring now to FIG. 6B, the way in which the covers 10, 110, 210 are formed will now be described. Specifically, FIG. 6B shows the formation of the cover 10 that is associated with FIGS. 1 through 3. Of course, the covers 110 and 110 that are illustrated in FIGS. 4 and 5 may also be formed in a like manner.

In order to produce the cover 10, the insert 14 containing the indicia 20 must be obtained. In many embodiments, this will occur by molding the insert 14 from the same (or substantially the same) material that is used to form the base 24. This molding will usually occur by placing the material in a mold or cast that has been pre-cut into the shape of the insert 14 (with the indicia 20). Other methods of obtaining/forming the insert may also be used. Likewise, those of skill in the art will appreciate how each specific insert 14 may be formed as well as the mechanisms used to produce a chrome plated indicia 20 or to have a multi-colored insert 14/indicia 20. Optionally, the insert 14 may also be affixed and/or positioned in a flange 68 to increase the area available for bonding with the insert 14.

Once the insert 14 has been obtained, the insert 14 may then be placed in a cover manufacturing tool 60. As shown in FIG. 6B, the tool 60 is a press or mold that is designed to mold/create airbag covers 10. Accordingly, the tool 60 will be designed and shape such that the ultimate product formed from the tool 60 will be that of the desired airbag cover 10. As noted above, pins or other retaining features (not shown) may be used to hold the insert 14 into the proper position within the tool 60. Such pins or other features will generally be designed to contact an inward or Class B surface of the insert 14 such that when the final cover 10 is finished, no indications or tokens of these pins are visible to the customer.

In some embodiments, the size of the insert 14 will be selected to be the exact same thickness as the tool 60 (when the cavity side 62 of the tool 60 is closed). Other embodiments may also be constructed such that the thickness of the insert 14 is less than the space within the tool 60. Further embodiments may be designed such that thickness of the insert 14 is greater (or slightly greater) than the thickness of the closed tool 60, thereby requiring some compression to close the cavity side 62 and resulting in an improved “shut-off” for the resulting airbag cover 10.

After the insert 14 has been introduced and positioned within the tool 60, a quantity of the base material 30 will then be introduced into the tool 60. Generally, the base material 30 will be hot—i.e., of sufficient temperature such that a bond will form between the insert 14 and the base material 30. As the base material 30 and the material of the insert 14 are the same (or substantially the same), this bond will generally be readily formed. Of course, if more adhesion and/or increased bond strength between the base 24 and the insert 14 is desired, a flange 68 (or other similar feature known in the art) may optionally be used and added to provide additional mechanical bonding.

Once the base material 30 has been introduced into the tool 60, the base material 30 will be molded about the insert 14. In many embodiments, this molding may involve closing the cavity side 62 of the tool 60 and applying sufficient pressure such that the base material 30 forms/molds into the desired form of the base 24 and forms a bond between the base 24 and the insert 14. As explained in greater detail above, generally the bond formed between the insert 14 and the base 24 will be such that there is a continuous fit between these two pieces without any sort of gap, ridge or other physical feature (i.e., other than color) demarking the boundaries of these two elements.

It should be noted that, in some embodiments, the tool 60 will be an injection molding machine. In these embodiments, the insert 14 will be inserted into one of the halves of the injection molding machine. Then, the cavity side 62 of the machine will be closed such that they two halves of the mold come together. As is known in the art, injection molding machines (and other types of airbag cover machines) will comprise two plates that are mounted on sliding rams (or other similar features) and may be pressed together. At this point, the material 30 is then introduced to the mold under pressure (and at a high temperature as described above). The injection molding machine will then mold the product (using sufficient pressure) such that the base material 30 forms/molds into the desired form of the base 24 and the base material 30 also forms a bond between the base 24 and the insert 14. As explained in greater detail above, generally the bond formed between the insert 14 and the base 24 will be such that there is a continuous fit between these two pieces without any sort of gap, ridge or other physical feature (i.e., other than color) demarking the boundaries of these two elements.

Once the cover 10 comes out of the tool 60, it will be complete and will already have the indicia 20 in its proper place. Likewise, the airbag cover 10 will have a desirable multi-colored appearance without the need to engage in masking or painting procedures. Further, the fact that the indicia is made of a different color than the base means that the manufacturer has a variety of different styling options without the need for secondary attachment mechanisms, specialized tooling features, or hard or rigid portions of the cover that may affect deployment of the airbag. Furthermore, because the insert and the base are made of substantially the same materials, the indicia will not unduly add mass to the system. As such, the present embodiments provide significant advantages over that which was previously known in the art.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag cover comprising:
a base; and
an insert made of substantially the same material as the base, the insert comprising an indicia that is a different color than the base, wherein the insert is melded to the base.

2. An airbag cover as in claim 1 wherein the insert is physically bonded to the base.

3. An airbag cover as in claim 1 wherein the insert is made of the same material as the base.

4. An airbag cover as in claim 1 wherein there is a continuous fit between the insert and the base.

5. An airbag cover as in claim 1 wherein the insert further comprises one or more flanges that provide an additional bonding area between the base and the insert.

6. An airbag cover as in claim 1 wherein at least a portion of the indicia is chrome plated.

7. An airbag cover as in claim 1 wherein the insert is sized to fit within a tool designed to mold airbag covers.

8. A method for manufacturing an airbag cover having an insert and a base, the insert comprising an indicia that is a different color than the base, the base being made of a base material that is substantially the same as the material used to make the insert, the method comprising the steps of:
placing an insert into a cover manufacturing tool;
closing the tool around the insert;
introducing the base material into the tool, wherein the base material is of a sufficient temperature and pressure such that it bonds to the insert; and
molding the base material about the insert.

9. A method as in claim 8 wherein the molding step bonds the base to the insert.

10. A method as in claim 8 wherein the insert comprises a flange that provides an additional bonding area between the insert and the base.

11. A method as in claim 8 wherein the insert comprises multiple colors.

12. A method as in claim 8 wherein there is a continuous fit between the insert and the base.

13. A method as in claim 8 wherein the insert is heated to a temperature that will mold the base material about the insert but will not deform the insert.

14. A method as in claim 8 wherein the insert has been pre-molded prior to placing the insert into the manufacturing tool

15. An insert for use in an airbag cover, the insert comprising an indicia and being made of a thermoplastic material, the insert being capable of being melded with a base to form the airbag cover, the insert being made of substantially the same material as the base.

16. An insert as in claim 15 wherein the indicia is made of a different color than the base.

17. An insert as in claim 15 wherein the insert is capable of bonding to the base as one.

18. An insert as in claim 15 wherein the insert is made of a material that may be melded to a base material, but will not deform during the melding process.
